(19) United States
(12) Patent Application Publication
(10) Pub. No.: US 2020/0080674 A1
(43) Pub. Date: Mar. 12, 2020

(54) WIRE SECUREMENT

(71) Applicant: GE Oil & Gas UK Limited, Bristol (GB)

(72) Inventors: Richard Alasdair CLEMENTS, Durham (GB); Paul Christopher SNOWDON, South Shields (GB)

(21) Appl. No.: 16/467,252

(22) PCT Filed: Dec. 11, 2017
(86) PCT No.: PCT/GB2017/053708

§ 371 Date: Jun. 6, 2019

(30) Foreign Application Priority Data
Dec. 14, 2016 (GB) 1621218.5

(51) Int. Cl. F16L 33/01

(52) U.S. Cl. CPC F16L 33/01; F16L 11/081

(57) ABSTRACT

A method and apparatus are disclosed. The apparatus includes a securing element body comprising a first elongate weakened region in the body extending along a respective first weakened region axis, a further elongate weakened region substantially orthogonal to the first weakened region axis and located proximate to a first end of the first weakened region, and a still further elongate weakened region substantially orthogonal to the first weakened region axis and located proximate to a remaining end of the first weakened region, wherein the further and still further weakened regions are disposed in a substantially parallel spaced apart relationship to provide at least one deformable region in the securing element body on a respective side of the first elongate weakened region.

The present invention relates to a method and apparatus for helping secure ends of armour wire of a flexible pipe within an end fitting. In particular, but not exclusively, the present invention relates to the addition of securing elements on ends of tensile armour wires of a flexible pipe, prior to their submersion in epoxy resin, as part of a pipe body termination operation. Affixing a body to the wire helps prevent extraction of the wire from the epoxy region during later use of the flexible pipe.

Traditionally flexible pipe is utilised to transport production fluids, such as oil and/or gas and/or water, from one location to another. Flexible pipe is particularly useful in connecting a sub-sea location (which may be deep underwater, say 1000 metres or more) to a sea level location. The pipe may have an internal diameter of typically up to around 0.6 metres (e.g. diameters may range from 0.05 m up to 0.6 m). A flexible pipe is generally formed as an assembly of flexible pipe body and one or more end fittings. The pipe body is typically formed as a combination of layered materials that form a pressure-containing conduit. The pipe structure allows large deflections without causing bending stresses that impair the pipe's functionality over its lifetime. There are different types of flexible pipe such as unbonded flexible pipe which is manufactured in accordance with API 17J or composite type flexible pipe or the like. The pipe body is generally built up as a combined structure including polymer layers and/or composite layers and/or metallic layers. For example, pipe body may include polymer and metal layers, or polymer and composite layers, or polymer, metal and composite layers. Layers may be formed from a single piece such as an extruded tube or by helically winding one or more wires at a desired pitch or by connecting together multiple discrete hoops that are arranged concentrically side-by-side. Depending upon the layers of the flexible pipe used and the type of flexible pipe some of the pipe layers may be bonded together or remain unbonded.

Some flexible pipe has been used for deep water (less than 3,300 feet (1,005.84 metres)) and ultra-deep water (greater than 3,300 feet) developments. It is the increasing demand for oil which is causing exploration to occur at greater and greater depths (for example in excess of 8202 feet (2500 metres)) where environmental factors are more extreme. For example in such deep and ultra-deep water environments ocean floor temperature increases the risk of production fluids cooling to a temperature that may lead to pipe blockage. In practice flexible pipe conventionally is designed to perform at operating temperatures of −30° C. to +130° C., and is being developed for even more extreme temperatures. Increased depths also increase a2 the pressure associated with the environment in which the flexible pipe must operate. For example, a flexible pipe may be required to operate with external pressures ranging from 0.1 MPa to 30 MPa acting on the pipe. Equally, transporting oil, gas or water may well give rise to high pressures acting on the flexible pipe from within, for example with internal pressures ranging from zero to 140 MPa from bore fluid acting on the pipe. As a result the need for high levels of performance from certain layers such as a pipe carcass or a pressure armour or a tensile armour layer of the flexible pipe body is increased. It is noted for the sake of completeness that flexible pipe may also be used for shallow water applications (for example less than around 500 metres depth) or even for shore (overland) applications.

When flexible pipe body is terminated at each end with an end fitting it is known that the various layers within the flexible pipe body must be cut and sealed as part of a termination process. Conventionally tensile armour wires which are wires helically wound along a length of the flexible pipe body are terminated in a complicated and therefore costly manner. Typically each tensile armour wire (there may be up to a hundred or more) must be bent away from a bore region of the flexible pipe body without overbending and then each armour wire must be cut to an appropriate length. The bending is required to access the ends of all of the tensile armour wires in the flexible pipe body to apply a crimp which thereafter helps anchor and thereby secure the wires in the end fitting. The bending back operation is dangerous as the wires splay around 360 degrees in a plane perpendicular to an axis of the pipe. The crimping of the wires is also potentially damaging to the wires as it requires very high levels of local deformation. Some methods of crimping may also attempt to stretch the wire which may sometimes result in wire breakage. Furthermore, a containment space (a volume) required for the crimped wires in the end fitting void space (which is later filled with a curable material such as an epoxy potting compound or the like) is also fairly large due to the build-up of space required with all adjacent and overlying crimped wires around the body of the end fitting. This results in a larger and thus heavier termination end fitting body being required which thereafter is difficult to handle.

After bending, the ends of the tensile armour wires are conventionally fixed in place with respect to the remainder of the end fitting by locating the crimped tensile armour wire ends in a space within the end fitting which is filled with epoxy resin as part of the termination process. As the curable epoxy solidifies the armour wire ends are interred within the epoxy material. Often this results in an adequate securing mechanism for securing end regions of tensile armour wire within an end fitting. However, as noted above, the process is time consuming, can be dangerous, is costly and furthermore is occasionally prone to tensile armour wires, which are under significant tensile stress in use, pulling free from the epoxy. This is because conventionally the epoxy only acts for frictional purposes against an outer (generally smooth) surface of any tensile wire.

It is an aim of the present invention to at least partly mitigate the above-mentioned problems.

It is an aim of certain embodiments of the present invention to help increase an extraction force needed to extract each and every (or at least some) tensile armour wire from an epoxied region within an end fitting.

It is an aim of certain embodiments of the present invention to help provide a mechanism whereby extraction of tensile armour wires from a desired position within an end fitting can be avoided wholly or at least partially.

It is an aim of certain embodiments of the present invention to provide an anchoring mechanism for helping to secure an end region of a tensile armour wire within an end fitting/termination in a manner which is cost effective and which is efficient for human operators involved in an end fitting operation to carry out and which results in an effective anchoring effect to secure wires in a desired location.

According to a first aspect of the present invention there is provided apparatus for securing an end region of a tensile armour wire of a flexible pipe within an end fitting, comprising:

a securing element body comprising a first elongate weakened region in the body extending along a respective first weakened region axis, a further elongate weakened region substantially orthogonal to the first weakened region axis and located proximate to a first end of the first weakened region, and a still further elongate weakened region substantially orthogonal to the first weakened region axis and located proximate to a remaining end of the first weakened region; wherein the further and still further weakened regions are disposed in a substantially parallel spaced apart relationship to provide at least one deformable region in the securing element body on a respective side of the first elongate weakened region.

Aptly the first elongate weakened region comprises a recessed region on at least a first side of the body.

Aptly the first elongate weakened region comprises a first recessed region and a further recessed region located in identical locations on each of a respective first and further side of the body.

Aptly the first elongate weakened region comprises a slot.

Aptly the slot is a through slot in the body.

Aptly the slot has a constant width that is less than a thickness of a tensile armour wire associated with the body.

Aptly the slot has a width of 2.8 to 8.0 mm.

Aptly at least one of the further and still further elongate weakened regions comprises a slit in the body.

Aptly both the further and still further elongate weakened regions comprises a slit.

Aptly each slit comprises a through slit.

Aptly each slit extends on only one side of the first weakened region axis to provide a generally C-shaped weakened region in the body.

Aptly each slit extends across the first weakened region axis to thereby provide a generally H-shaped weakened region in the body.

Aptly the at least one weakened region comprises a pinched region of the body or a reduced thickness region of the body.

Aptly the at least one weakened region comprises a perforation line in the body.

Aptly the securing element body comprises a substantially planar body.

Aptly the planar body comprises a substantially circular or oval disc or rectangular plate having a thickness of about around 2.0 to 5.0 mm.

Aptly the disc or plate is a metal or ceramic or polymer or composite element.

Aptly the disc is a stainless steel or aluminium disc.

Aptly the securing element body is a pressed or moulded or dye cast or laser cut or punched or water cut or stamped out element.

Aptly the body further comprises an indicium or indicia that indicates an association with the body and a respective type of tensile armour wire.

Aptly the indicia or indicium comprises a colour of or on the body.

Aptly the indicia or indicium comprises at least one pressed or moulded or cast or cut or punched or stamped mark on or in the body.

Aptly at least one further securing element body comprising a respective first, further and still further weakened region substantially parallel to and spaced apart from said a securing element.

Aptly each securing element body is commonly orientated so that each first weakened region of each body is disposed in a commonly aligned orientation.

Aptly each securing element body is permanently fixed to at least one other securing element body in a parallel spaced apart relationship.

Aptly each securing element body comprises a first and a remaining side and each side comprises an abutment surface for increasing resistance to being removed when the securing element body is surrounded by epoxy material.

Aptly each abutment surface is substantially smooth.

Aptly each abutment surface comprises at least one additional resistance element.

According to a second aspect of the present invention there is provided a self-attaching securing element for attaching to a tensile armour wire, said element comprising:
a body including at least one deformable region that is deformable to receive a respective tensile armour wire, when the wire is threaded through an opening in the body, and that is arranged to simultaneously prevent removal of the attached body from the wire subsequent to the body being threaded onto the wire.

According to a third aspect of the present invention there is provided a method of securing an end region of at least one flexible pipe body tensile armour wire in an end fitting, comprising the steps of:
threading a free end region of a tensile armour wire through a securing element body; and
as the tensile armour wire is threaded, deforming at least one region in the securing body; whereby
each at least one region deforms to resist subsequent movement of the body with respect to the tensile armour wire in a direction towards the free end.

Aptly the method further comprises threading the free end region by urging a wire tip at a first elongate weakened region of the securing element body.

Aptly the method further comprises deforming said at least one region by urging material located between a further and still further elongate weakened region of the securing element body out of a major plane of the securing element body towards a downstream side of the body.

Aptly the method further comprises deforming said at least one region by urging material located between the further and still further elongate weakened regions on a first and further adjacent side of a first elongate weakened region towards the downstream side of the body thereby providing a respective first and further gripping surface on an outer surface of the threaded tensile armour wire.

Aptly the method further comprises threading the free end regions through the securing element body by urging the free end region of the tensile armour wire through a slot disposed centrally in the securing element body.

Aptly the method further comprises breaking through at least one perforation line as the tensile armour wire is threaded on the body.

Aptly the method further comprises sliding each securing element body away from a wire tip of a tensile armour wire threaded through the body until the securing element body is positioned a predetermined distance from the wire tip.

Aptly the method further comprises locating a plurality of tensile armour wires, each threaded through at least one respective securing element body, in a securing pocket between an end fitting jacket member and an end fitting body.

According to a fourth aspect of the present invention there is provided a method of terminating flexible pipe body in an end fitting, comprising the steps of:
providing an end fitting body comprising a connecting flange at a first end fitting end and an open mouth at a further end fitting end;
threading an end of each tensile armour wire of a plurality of tensile armour wires through at least one respective securing element body simultaneously deforming at least one region of the securing element body to thereby resist subsequent withdrawal of the tensile armour wire from the securing element body;
securing a jacket member to the end fitting body thereby providing a pocket region in the end fitting where end regions of said plurality of tensile armour wires are located; and

subsequently providing a curable material in the pocket region.

Aptly the method further comprises subsequently curing the curable material.

Aptly the method further comprises anchoring the tensile armour wire end regions in the cured material in the pocket region via the securing element bodies on the tensile armour wire end regions.

According to a fifth aspect of the present invention there is provided apparatus constructed and arranged substantially as hereinbefore described with reference to the accompanying drawings.

According to a sixth aspect of the present invention there is provided a method substantially as herein before described with reference to the accompanying drawings.

Certain embodiments of the present invention provide a cost effective solution for securing ends of tensile armour wire in an epoxied region within an end fitting. Securing bodies which can be threaded over each wire are provided and each of these helps anchor a respective wire in position and can be readily utilised by an operator.

Certain embodiments of the present invention provide securing bodies which are cheap to manufacture and which are easy to use.

Certain embodiments of the present invention provide a mechanism by which one or more elements can be fixed on a tensile armour wire to increase its effective cross-section at specific locations along its length. The bodies secured on each wire automatically energise into an operative state, whereby their removal from an outer surface of a tensile armour wire is restricted, as part of the process by which the bodies are themselves initially affixed to the armour wires.

Certain embodiments of the present invention provide for the application of slotted and/or slitted discs onto tensile armour wires. Optionally the slots in the discs are slightly under-sized compared to a cross-section of a tensile armour wire design being used. As a result an interference fit removes a need to crimp a tensile wire. This helps provide an easier and quicker and safer anchoring operation to help secure a tensile armour wire in an end fitting than is currently available with conventional techniques. Alternatively part or parts of the securing body is made to deform to produce a spring fit.

Certain embodiments of the present invention provide securing element bodies in the forms of slotted and/or slit discs which can slide onto wires up to a set distance. Optionally a small single depression may be pre-applied to a wire (for example a wire may be squashed or reduced in at least one of its dimensions locally by a small amount). The spring action of the slot or slit in the disc like body secures the securing element body on the wire through slightly digging into the wire itself or through being under-sized compared to most of the wire but matched with the wire at the position of a locating recess applied to the wire.

Certain embodiments of the present invention will now be described hereinafter, by way of example only, with reference to the accompanying drawings in which:

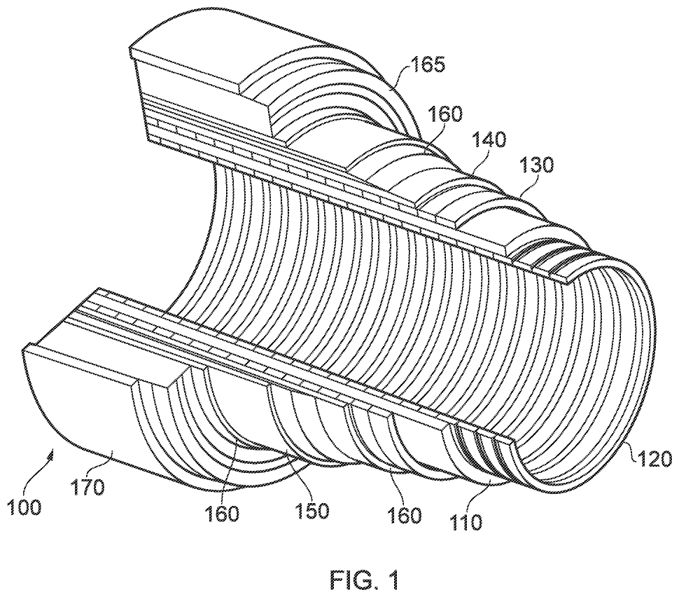

FIG. 1 illustrates flexible pipe body;

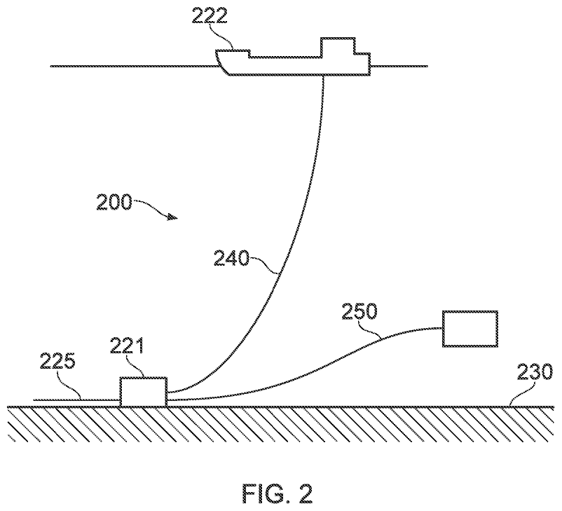

FIG. 2 illustrates certain uses of a flexible pipe;

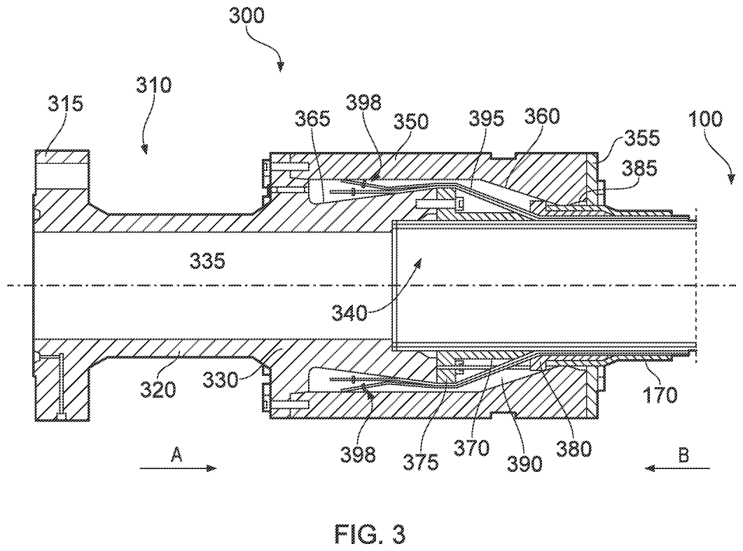

FIG. 3 helps illustrate an end of a flexible pipe where flexible pipe body is terminated in an end fitting;

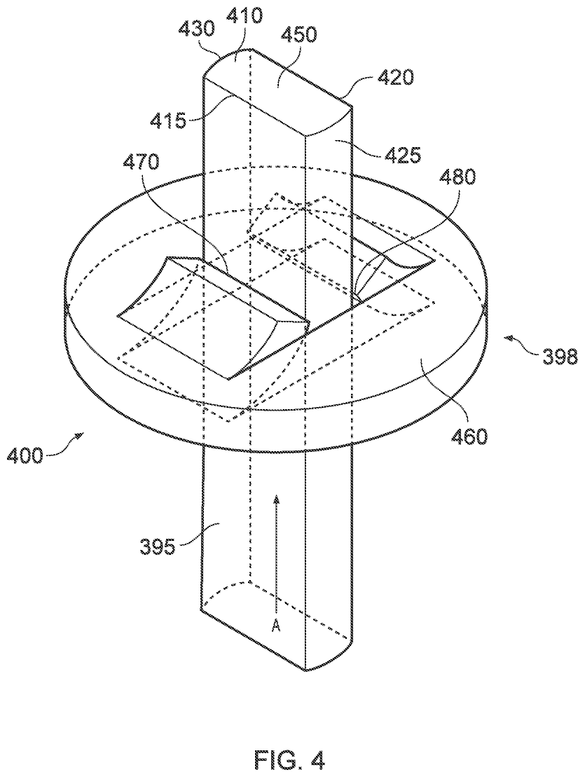

FIG. 4 illustrates a securing body threaded onto a tensile armour wire;

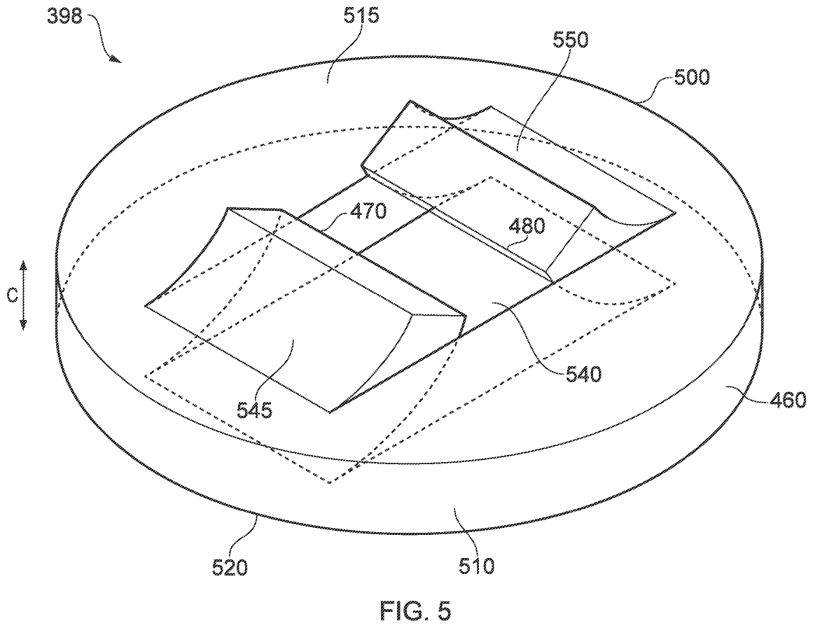

FIG. 5 illustrates a securing body;

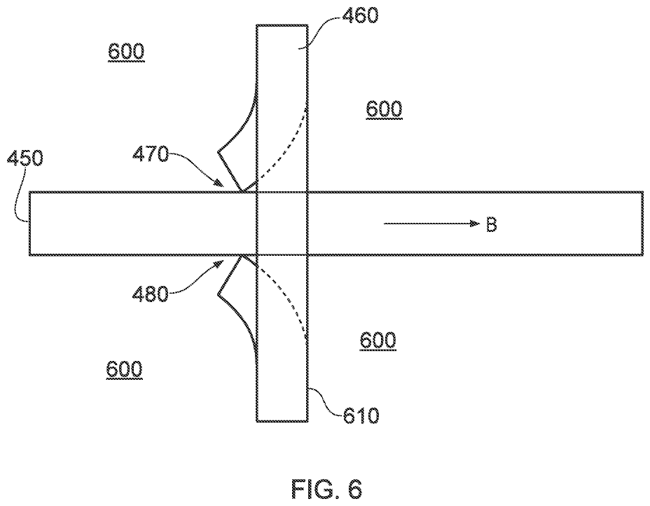

FIG. 6 illustrates a cross-section of a tensile armour wire with a securing body active to prevent removal of the body from the tensile armour wire by sliding;

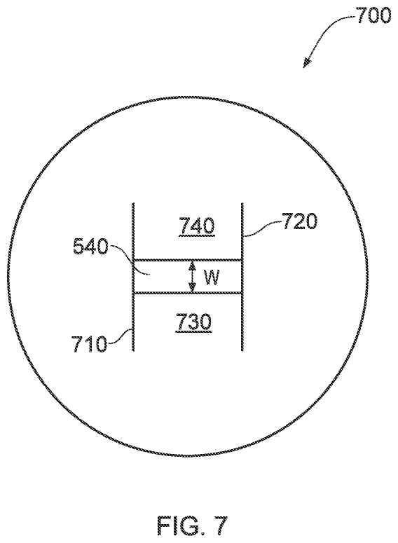

FIG. 7 illustrates a plan view of a securing body blank with a slot and slits;

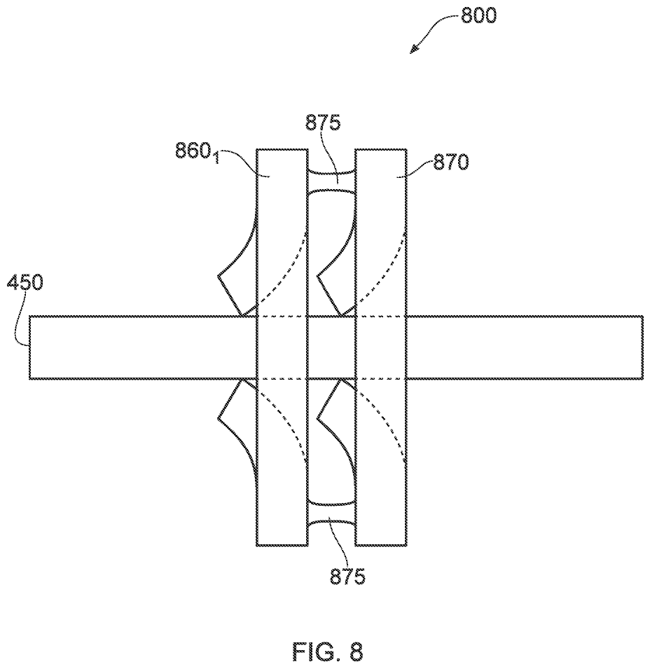

FIG. 8 illustrates how two bodies can be secured together to form a single securing element body;

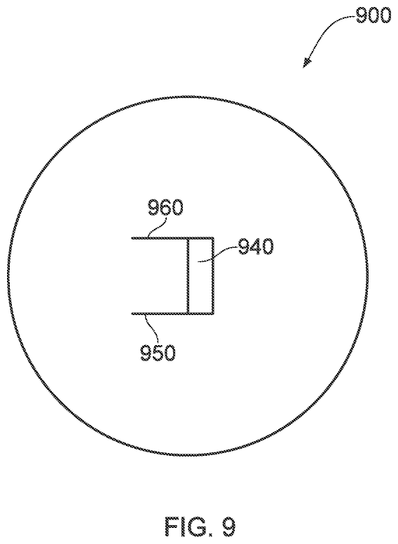

FIG. 9 illustrates an alternative securing body blank with a slot and two slits to one slide of the slot;

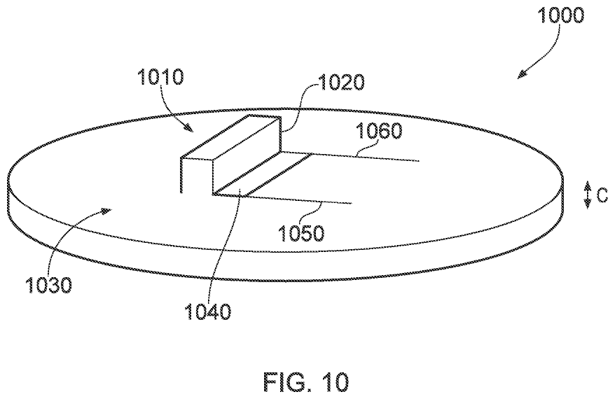

FIG. 10 helps illustrate a moulded securing body blank;

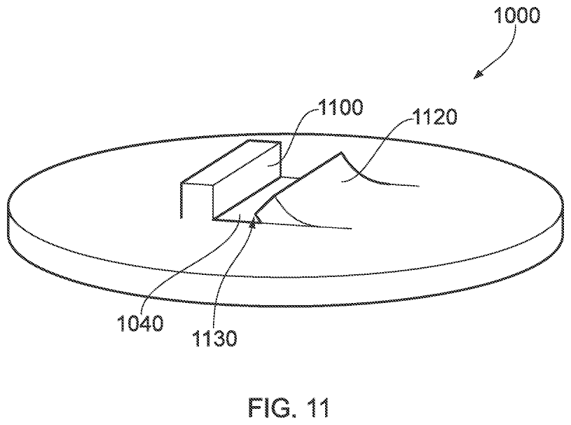

FIG. 11 illustrates the securing body shown in FIG. 10 in which part of the body is deformed as a tensile armour wire (not shown) is urged/threaded through a central slot.

In the drawings like reference numerals refer to like parts.

Throughout this description, reference will be made to a flexible pipe. It is to be appreciated that certain embodiments of the present invention are applicable to use with a wide variety of flexible pipe. For example certain embodiments of the present invention can be used with respect to flexible pipe and associated end fittings of the type which is manufactured according to API 17J. Such flexible pipe is often referred to as unbonded flexible pipe. Other embodiments are associated with other types of flexible pipe.

Turning to FIG. 1 it will be understood that the illustrated flexible pipe is an assembly of a portion of pipe body and one or more end fittings (not shown) in each of which a respective end of the pipe body is terminated. FIG. 1 illustrates how pipe body 100 is formed from a combination of layered materials that form a pressure-containing conduit. As noted above although a number of particular layers are illustrated in FIG. 1, it is to be understood that certain embodiments of the present invention are broadly applicable to coaxial pipe body structures including two or more layers manufactured from a variety of possible materials. The pipe body may include one or more layers comprising composite materials, forming a tubular composite layer. It is to be further noted that the layer thicknesses are shown for illustrative purposes only. As used herein, the term “composite” is used to broadly refer to a material that is formed from two or more different materials, for example a material formed from a matrix material and reinforcement fibres.

A tubular composite layer is thus a layer having a generally tubular shape formed of composite material. Alternatively a tubular composite layer is a layer having a generally tubular shape formed from multiple components one or more of which is formed of a composite material. The layer or any element of the composite layer may be manufactured via an extrusion, pultrusion or deposition process or, by a winding process in which adjacent windings of tape which themselves have a composite structure are consolidated together with adjacent windings. The composite material, regardless of manufacturing technique used, may optionally include a matrix or body of material having a first characteristic in which further elements having different physical characteristics are embedded. That is to say elongate fibres which are aligned to some extent or smaller fibres randomly orientated can be set into a main body or spheres or other regular or irregular shaped particles can be embedded in a matrix material, or a combination of more than one of the above. Aptly the matrix material is a thermoplastic material, aptly the thermoplastic material is polyethylene or polypropylene or nylon or PVC or PVDF or PFA or PEEK or PTFE or alloys of such materials with reinforcing fibres manufactured from one or more of glass, ceramic, basalt, carbon, carbon nanotubes, polyester, nylon, aramid, steel, nickel alloy, titanium alloy, aluminium alloy or the like or fillers manufactured from glass, ceramic, carbon, metals, buckminsterfullerenes, metal silicates, carbides, carbonates, oxides or the like.

The pipe body 100 illustrated in FIG. 1 includes an internal pressure sheath 110 which acts as a fluid retaining layer and comprises a polymer layer that ensures internal fluid integrity. The layer provides a boundary for any conveyed fluid. It is to be understood that this layer may itself comprise a number of sub-layers. It will be appreciated that when a carcass layer 120 is utilised the internal pressure sheath is often referred to by those skilled in the art as a barrier layer. In operation without such a carcass (so-called smooth bore operation) the internal pressure sheath may be referred to as a liner. A barrier layer 110 is illustrated in FIG. 1.

It is noted that a carcass layer 120 is a pressure resistant layer that provides an interlocked construction that can be used as the innermost layer to prevent, totally or partially, collapse of the internal pressure sheath 110 due to pipe decompression, external pressure, and tensile armour pressure and mechanical crushing loads. The carcass is a crush resistant layer. It will be appreciated that certain embodiments of the present invention are thus applicable to ‘rough bore’ applications (with a carcass). Aptly the carcass layer is a metallic layer. Aptly the carcass layer is formed from stainless steel, corrosion resistant nickel alloy or the like. Aptly the carcass layer is formed from a composite, polymer, or other material, or a combination of materials and components. A carcass layer is radially positioned within the barrier layer.

A pressure armour layer 130 is a pressure resistant layer that provides a structural layer that increases the resistance of the flexible pipe to internal and external pressure and mechanical crushing loads. The layer also structurally supports the internal pressure sheath. Aptly as illustrated in FIG. 1 the pressure armour layer is formed as a tubular layer. Aptly for unbonded type flexible pipe the pressure armour layer consists of an interlocked construction of wires with a lay angle close to 90°. Aptly in this case the pressure armour layer is a metallic layer. Aptly the pressure armour layer is formed from carbon steel, aluminium alloy or the like. Aptly the pressure armour layer is formed from a pultruded composite interlocking layer. Aptly the pressure armour layer is formed from a composite formed by extrusion or pultrusion or deposition. A pressure armour layer is positioned radially outside an underlying barrier layer.

The flexible pipe body also includes a first tensile armour layer 140 and second tensile armour layer 150. Each tensile armour layer is used to sustain tensile loads and optionally also internal pressure. Aptly for some flexible pipes the tensile armour windings are metal (for example steel, stainless steel or titanium or the like). For some composite flexible pipes the tensile armour windings may be polymer composite tape windings (for example provided with either thermoplastic, for instance nylon, matrix composite or thermoset, for instance epoxy, matrix composite). For unbonded flexible pipe the tensile armour layer is typically formed from a plurality of wires. (To impart strength to the layer) that are located over an inner layer and are helically wound along the length of the pipe at a lay angle typically between about 10° to 55°. Aptly the tensile armour layers are counter-wound in pairs. Aptly the tensile armour layers are metallic layers. Aptly the tensile armour layers are formed from carbon steel, stainless steel, titanium alloy, aluminium alloy or the like. Aptly the tensile armour layers are formed from a composite, polymer, or other material, or a combination of materials.

Aptly the flexible pipe body includes optional layers of tape 160 which help contain underlying layers and to some extent prevent abrasion between adjacent layers. The tape layer may optionally be a polymer or composite or a combination of materials, also optionally comprising a tubular composite layer. Tape layers can be used to help prevent metal-to-metal contact to help prevent wear. Tape layers over tensile armours can also help prevent “birdcaging”.

The flexible pipe body also includes optional layers of insulation 165 and an outer sheath 170, which comprises a polymer layer used to protect the pipe against penetration of seawater and other external environments, corrosion, abrasion and mechanical damage. Any thermal insulation layer helps limit heat loss through the pipe wall to the surrounding environment.

Each flexible pipe comprises at least one portion, referred to as a segment or section, of pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

FIG. 2 illustrates a riser assembly 200 suitable for transporting production fluid such as oil and/or gas and/or water from a sub-sea location 221 to a floating facility 222. For example, in FIG. 2 the sub-sea location 221 includes a sub-sea flow line 225. The flexible flow line 225 comprises a flexible pipe, wholly or in part, resting on the sea floor 230 or buried below the sea floor and used in a static application. The floating facility may be provided by a platform and/or buoy or, as illustrated in FIG. 2, a ship. The riser assembly 200 is provided as a flexible riser, that is to say a flexible pipe 240 connecting the ship to the sea floor installation. The flexible pipe may be in segments of flexible pipe body with connecting end fittings.

It will be appreciated that there are different types of riser, as is well-known by those skilled in the art. Certain embodiments of the present invention may be used with any type of riser, such as a freely suspended (free-hanging, catenary riser), a riser restrained to some extent (buoys, chains), totally restrained riser or enclosed in a tube (I or J tubes). Some, though not all, examples of such configurations can be found in API 17J. FIG. 2 also illustrates how portions of flexible pipe can be utilised as a jumper 250.

FIG. 3 helps illustrate how a respective end of a segment of flexible pipe body 100 can be terminated in an end fitting 300. The end fitting 300 includes a main end fitting body 310 which includes a flanged end 315 which acts as a connector for securing to another end fitting in a back-to-back relationship or to a rigid structure. A narrow neck 320 extends into a central flared out region 330. The end fitting 300 includes an end fitting body 310 which defines an internal bore 335 running along a length of the end fitting body. This bore has a diameter to match a corresponding bore of the flexible pipe body. The end fitting body is made from steel or some other such rigid material. The flanged end region 315 provides a connector at a first end of the end fitting body. The other end of the end fitting body defines an open mouth 340 into which an end of a segment of flexible pipe body is received. The flanged connector is a substantially disc-like flared region of the end fitting body. The connector can be connected directly to a matching connector or a further end fitting body of an adjacent segment of flexible pipe body. This can be done using bolts or some other form of securing mechanism. Alternatively the connector 315 may be connected to a floating or stationery structure such as a ship, platform or the like. Various layers of flexible pipe body are introduced to the end fitting assembly, cut to an appropriate length, and sealingly engaged with a particular portion of the end fitting.

As illustrated in FIG. 3 the end fitting 300 also includes a jacket 350 which is secured at a first end of the jacket to the central flanged region of the end fitting body. The jacket has a substantially cylindrical outer surface. A remaining end of the jacket 350 is secured to an end plate 355. A radially inner surface 360 of the jacket remains spaced apart from a radially outer surface 365 of the open mouth end of the end fitting body 310 and a radially outer surface 370 of an inner collar 375. An outer collar 380 helps urge an outer sheath 170 against an outer seal 385. The spaced apart relationship of the inner surface 360 of the jacket and radially outer surfaces of the end fitting body and inner collar define a pocket region 390 or void into which tensile armour wires 395 of the first tensile armour layer 140 and second tensile armour layer 150 are terminated. As part of a terminating process the space in the pocket region 390 is filled with a curable material subsequent to the jacket being secured to the end fitting body. The curable material, such as epoxy resin, or the like solidifies to inter the tensile armour wires 395 in the pocket region. As illustrated in FIG. 3 securing element bodies 398 are secured to end regions of the tensile armour wires at a predetermined distance from a tip of each wire to help anchor the tensile armour wires in the curable material. This helps increase resistance to the tensile armour wires being pulled through the epoxy material. This increases an extraction force needed to extract the wires.

FIG. 4 helps illustrate an end region 400 of a particular tensile armour wire 395 in more detail. The tensile armour wire 395 shown in FIG. 4 has a generally rectangular cross section 410 with substantially parallel spaced apart long edges 415, 420 spaced apart by shorter edges 425, 430. The shorter edges 425, 430 illustrated in the tensile armour wire shown in FIG. 4 are slightly curved whereas the longer edges define substantially flat upper and lower surfaces for the tensile armour wires. It will be appreciated that certain embodiments of the present invention are broadly applicable to tensile armour wires and their anchoring having a wide selection of possible cross sections. Multiple helically wound tensile armour wires make up the inner and outer tensile armour layers of the flexible pipe body.

FIG. 4 helps illustrate an end 450 of a respective tensile armour wire and how this can be urged through a securing element body 460 in a threading motion. Thereafter the securing element body 460 can be slid along the outer surface of a tensile armour wire until it reaches a predetermined distance from the wire tip 450. Aptly this is 5 cm. Aptly this is between 4 and 15 cm from the wire end.

As illustrated in FIG. 4 as the tensile armour wire is threaded through the body 460 parts of the body deform out of a plane of the body in the direction in which the tensile armour wire is urged during a threading process. This is illustrated by the arrow A illustrated in FIG. 4. In other words the deformed regions deform to a side of the securing element body 460 in a direction of advancement of the tensile armour wire as it is affixed to the securing body 460. As will be appreciated by those skilled in the art the deformation of the material of the body 460 results in opposed contact surfaces 470, 480 which will bite on to an outer surface of a tensile armour wire in the event that the tensile armour wire is pulled or otherwise urged in an opposite direction i.e, in a direction opposite to the arrow A shown in FIG. 4. Such motion would be expected during use of a flexible pipe when forces on the tensile armour wires would tend to pull them away from the end fitting body. By deforming the securing element body 460 in the way shown in FIG. 4 the process of threading the body on the tensile armour wire also helps self-energise the deformed regions into a state where they will thereafter automatically resist counter motion of the tensile armour wire. It will also be understood that the orientation of the slot in the securing body may be as shown in FIG. 4 or may be 90° (or other angles) to this so that the opposed contact surfaces 470, 480 contact the shorter edges 425, 430 of the wire instead of long edges.

FIG. 5 helps illustrate a securing element body 398 in more detail. As illustrated in FIG. 5 the securing element body 398 is provided by a substantially disc-like body 460. This may be manufactured from stainless steel or steel or other metallic material or indeed any other rigid material. For example rather than a metal the body may be manufactured from a polymer-like material which can be moulded and/or extruded (see later). The body 460 illustrated in FIG. 5 is substantially circular having an outer circumference 500 which defines an edge 510. Other non-circular shapes could be utilised for example rectangular or oval. In the current embodiment, a first substantially planer surface 515 which is substantially circular is spaced apart from a further substantially planer circular surface 520. The distance between the first and further sides 515, 520 of the disc-like body 460 define a thickness t of the body 460. Aptly this thickness is between 4 mm-20 mm. Aptly the thickness is about around 6 mm to 9 mm.

FIG. 5 illustrates the body in a deformed state. That is to say a central slot 540 has been widened by adjacent material on either side of the slot 540 being deformed outwardly from an imaginary plane associated with the disc-like body towards the first side of the body. As a result of the deformation a first gripping region 545 deforms upwardly and is opposed, across the slot, by a further deformed gripping region 550. An edge 470 of the first gripping region 545 will provide a bite on to an outer surface of the tensile armour wire. A further gripping edge 480 will likewise bite on the outer surface of another side of a tensile armour wire urged through the central slot 540 in the body 460.

FIG. 6 helps illustrate the end 450 of the tensile armour wire shown in FIG. 4 in more detail and helps illustrate a side view of the securing element body 460 when the tensile armour wire is threaded through a central region of the body. It will be appreciated that certain other embodiments of the present invention utilise a threading process in which tensile armour wire is urged through a weakened zone of a securing element body whereby the weakened zone may be off centre and/or may extend from an edge of the body towards a more central region.

As illustrated in FIG. 6 a first gripping edge 470 of a deformed region of the body and an opposed gripping edge 480 on a further deformed region of the securing element body bite into respective outer surfaces of the tensile armour wire. In use forces on a tensile armour wire would tend to try to urge the tensile armour wire in a direction illustrated by arrow B in FIG. 6. In the instance where the wire and securing body 460 are interred in cured epoxy material 600 the abutment surface 610 provided by the right hand side (in FIG. 6) side 520 of the securing element body behaves as an anchor to prevent motion of the end region of the wire and securing element in the direction shown by arrow B through the epoxy material. The securing element body 460 thus helps effectively increase the cross section of material that has to be pulled through cured epoxy. The deformed regions of the body act to help lock the securing element body to the tensile armour wire to help avoid relative motion which might otherwise permit the tensile armour wire to simply be pulled away from the securing element body and thereafter out of the epoxy.

FIG. 7 helps illustrate how weakened regions may be provided in a blank 700 to help provide the securing element body. As illustrated in FIG. 7 a blank 700 is formed with a central slot 540 which has a width w selected according to an armour wire thickness which it is to be used with. The blank 700 shown is a metallic disc but other materials and shapes could be utilised. The slot provides a first elongate weakened region in the material of the securing element body. The slot has an associated longitudinal axis.

Two spaced apart slits 710, 720 are provided in the blank 700. A first slit 710 is substantially orthogonal to the longitudinal axis of the slot 540 and extends at a respective end of the slot. The first slit 710 illustrated in FIG. 7 extends on both sides of the slot. The remaining slit 720 is likewise located orthogonal to the longitudinal axis of the slot but at the other end of the slot and extends on both sides of the slot. By providing slitted material on each side of the slot 540 a first deformable zone 730 and a further deformable zone 740 are defined. These deformable zones become the first and further gripping regions 545, 550 when an end of an armour wire is urged towards the slot 540 as part of the affixing process which secures a body to a tensile armour wire.

By manufacturing blanks 700 in this way a very cost effective way of manufacturing and thus providing securing element bodies suitable for affixing to tensile armour wires is provided. It will be appreciated that according to certain embodiments of the present invention weakened regions within a blank may be provided in different ways. For example a line of perforations may be formed rather than a slit or slot.

FIG. 8 illustrates an alternative embodiment in which a securing element body 800 that can be secured on an end region of a tensile armour wire to help secure an end region of a tensile armour wire of a flexible pipe within an end fitting includes two spaced apart disc-like bodies 860, 870 which are secured together in a spaced apart relationship. As illustrated in FIG. 8 the two substantially parallel spaced apart bodies are secured by a circular weld line 875 provided as a series of spot welds. The weld acts as a spacer as well as a connector so that the two spaced apart bodies move as one. It will be appreciated that any other securing mechanism can be utilised to secure the first and further securing element body parts together. For example the parts can be stamped or crimped or bolted together or screwed together or the like.

As illustrated in FIG. 8 each securing element body has at least one deformable region (two shown in FIG. 8) which each provide a respective biting point on an outer surface of a tensile armour wire when the body is affixed to the tensile armour wire. It will be likewise understood that whilst two spaced apart body parts are illustrated in FIG. 8 more than two spaced apart body parts may be utilised according to certain other embodiments of the present invention.

FIG. 9 helps illustrate an alternative blank 900. In many respects this blank 900 is similar to the blank 700 illustrated in FIG. 7. However the blank 900 illustrated in FIG. 9, whilst including a central slot 940, includes slits 950, 960 which extend only to one side of a longitudinal axis associated with the central slot 940. It will be appreciated that according to such embodiments only one deformable region is provided to provide a single biting point (albeit a bite line) on an outer surface of the tensile armour wire. The two spaced apart slits 950, 960 each provide a respective weakened region in the blank 900. This can be deformed in use to help receive a tensile wire and provide a lock on the wire.

It will be appreciated that rather than provide a slot in a blank slits may alternately be provided which effectively define a region of a blank which can be punched out when a tensile armour wire is affixed with respect to the securing element body. In this way each weakened region can be provided by a through slit or perforated slit or blind slit as appropriate.

The blanks previously discussed thus provide a self-attaching securing element for attaching to a tensile armour wire. In each case the element comprises a body which includes at least one deformable region that is deformable to receive a respective tensile armour wire when the wire is threaded through the body. This simultaneously enables material from the body to move aside to enable a tensile armour wire to be threaded through the body and also helps prevent removal of an attached body from the wire subsequent to the body being threaded onto the wire. Such self-attaching securing elements can be utilised to help secure an end region of at least one flexible pipe body tensile armour wire in an end fitting as one or more bodies can be threaded onto a free end of a tensile armour wire and these remain locked in position with respect to the wire and provide an abutment surface which effectively increases a cross-section to the wire which must be pulled through a resin reservoir to remove a wire.

FIG. 10 illustrates an alternative blank 1000 for an alternative securing element body. The blank 1000 illustrated in FIG. 10 is a moulded plastic body although it will likewise be appreciated by those skilled in the art that a moulded metallic material could be utilised or any other rigid material such as a composite material. The body could likewise be milled or cut or formed by an additive manufacturing process. In contrast to the previously described blanks the blank illustrated in FIG. 10 does not have a uniform cross-section in its innate state. Rather, as shown in FIG. 10, the blank has a substantially uniform cross-section thickness C apart from in a generally central location 1010 where an upstanding bar 1020 extends outwardly from an upper surface 1030 of the blank 1000. A slot 1040 lies alongside the bar 1020 and spaced apart slits 1050, 1060 extend in a spaced apart parallel fashion away from respective ends of the slot 1040, As with the previously mentioned slits, the slits may be through slits or blind slits.

FIG. 11 helps illustrate how the securing element body 1000 illustrated in FIG. 10 deforms when a tensile armour wire (not shown) is thrust through the weakened areas provided by the slot 1040 and slits in the body. The bar provides an abutment surface 1100 against which the tensile armour wire will rest as it passes through the securing body. The single deformed region 1120 between the slits 1050, 1060, is urged outwardly out of a plane associated with the securing body by the tensile armour wire passing through the slot. The deformed region 1120 provides a respective biting surface 1130 (which will be a line in the deformed surface shown in FIG. 11) which will be urged against the tensile armour wire in use to prevent rearward motion of the tensile armour wire as it tends to extract itself from the body and the end fitting in use.

According to certain embodiments described hereinabove a method of terminating flexible pipe body in an end fitting can be achieved by providing an end fitting body including a connecting flange at a first end and an open mouth at a further end, threading an end of one or more tensile armour wires of a segment of flexible pipe body through respective securing element bodies (thereby simultaneously deforming at least one region of the body to thereby resist subsequent withdrawal of the tensile armour wire from the securing element body), securing a jacket member to the end fitting body thereby providing a pocket region within the end fitting where the tensile armour wire ends are located and subsequently providing a curable material in the pocket region. Aptly the curable material is an epoxy resin and this can subsequently be cured to inter the armour wire ends in epoxy material. The disc like bodies affixed to the wires are difficult to pull through the epoxy and difficult to remove from the wires.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. Apparatus for securing an end region of a tensile armour wire of a flexible pipe within an end fitting, comprising:
a securing element body comprising a first elongate weakened region in the body extending along a respective first weakened region axis, a further elongate weakened region substantially orthogonal to the first weakened region axis and located proximate to a first end of the first weakened region, and a still further elongate weakened region substantially orthogonal to the first weakened region axis and located proximate to a remaining end of the first weakened region; wherein
the further and still further weakened regions are disposed in a substantially parallel spaced apart relationship to provide at least one deformable region in the securing element body on a respective side of the first elongate weakened region.

2. The apparatus as claimed in claim 1, further comprising:
the first elongate weakened region comprises a recessed region on at least a first side of the body; and
optionally the first elongate weakened region comprises a first recessed region and a further recessed region located in identical locations on each of a respective first and further side of the body.

3. (canceled)

4. The apparatus as claimed in claim 1, further comprising:
the first elongate weakened region comprises a slot; and
optionally the slot has a constant width that is less than a thickness of a tensile armour wire associated with the body.

5. (canceled)

6. (canceled)

7. (canceled)

8. The apparatus as claimed in claim 1, further comprising:
at least one of the further and still further elongate weakened regions comprises a slit in the body.

9. (canceled)

10. (canceled)

11. The apparatus as claimed in claim 8, further comprising:
each slit extends on only one side of the first weakened region axis to provide a generally C-shaped weakened region in the body or each slit extends across the first weakened region axis to thereby provide a generally H-shaped weakened region in the body.

12. (canceled)

13. The apparatus as claimed in claim 1, further comprising:
the at least one weakened region comprises a pinched region of the body or a reduced thickness region of the body;
or the at least one weakened region comprises a perforation line in the body.

14. (canceled)

15. The apparatus as claimed in claim 1, further comprising:
the securing element body comprises a substantially planar body.

16. The apparatus as claimed in claim 15, further comprising:
the planar body comprises a substantially circular or oval disc or rectangular plate having a thickness of about around 2.0 to 5.0 mm;
and optionally the disc or plate is a metal or ceramic or polymer or composite element.

17. (canceled)

18. (canceled)

19. (canceled)

20. The apparatus as claimed in claim 1, further comprising:
the body further comprises an indicium or indicia that indicates an association with the body and a respective type of tensile armour wire.

21. The apparatus as claimed in claim 20, further comprising:
the indicia or indicium comprises a colour of or on the body;
or the indicia or indicium comprises at least one pressed or moulded or cast or cut or punched or stamped mark on or in the body.

22. (canceled)

23. The apparatus as claimed in claim 1, further comprising:
at least one further securing element body comprising a respective first, further and still further weakened region substantially parallel to and spaced apart from said a securing element.

24. The apparatus as claimed in claim 23, further comprising:
each securing element body is commonly orientated so that each first weakened region of each body is disposed in a commonly aligned orientation; and
optionally each securing element body is permanently fixed to at least one other securing element body in a parallel spaced apart relationship.

25. (canceled)

26. The apparatus as claimed in claim 1, further comprising:
each securing element body comprises a first and a remaining side and each side comprises an abutment surface for increasing resistance to being removed when the securing element body is surrounded by epoxy material.

27. The apparatus as claimed in claim 26, further comprising:
each abutment surface is substantially smooth;
or each abutment surface comprises at least one additional resistance element.

28. (canceled)

29. A self-attaching securing element for attaching to a tensile armour wire, said element comprising:
a body including at least one deformable region that is deformable to receive a respective tensile armour wire, when the wire is threaded through an opening in the body, and that is arranged to simultaneously prevent removal of the attached body from the wire subsequent to the body being threaded onto the wire.

30. A method of securing an end region of at least one flexible pipe body tensile armour wire in an end fitting, comprising the steps of:
threading a free end region of a tensile armour wire through a securing element body; and
as the tensile armour wire is threaded, deforming at least one region in the securing body; whereby
each at least one region deforms to resist subsequent movement of the body with respect to the tensile armour wire in a direction towards the free end.

31. (canceled)

32. The method as claimed in claim 30, further comprising:
deforming said at least one region by urging material located between a further and still further elongate weakened region of the securing element body out of a major plane of the securing element body towards a downstream side of the body; and
optionally deforming said at least one region by urging material located between the further and still further elongate weakened regions on a first and further adjacent side of a first elongate weakened region towards the downstream side of the body thereby providing a respective first and further gripping surface on an outer surface of the threaded tensile armour wire.

33. (canceled)

34. (canceled)

35. The method as claimed in claim 30, further comprising:
breaking through at least one perforation line as the tensile armour wire is threaded on the body.

36. The method as claimed in claim 30, further comprising:
sliding each securing element body away from a wire tip of a tensile armour wire threaded through the body until the securing element body is positioned a predetermined distance from the wire tip.

37. The method as claimed in claim 30, further comprising:
locating a plurality of tensile armour wires, each threaded through at least one respective securing element body, in a securing pocket between an end fitting jacket member and an end fitting body.

38. (canceled)

39. (canceled)

40. (canceled)
